(19) United States
(12) Patent Application Publication
(10) Pub. No.: US 2017/0091150 A1
(43) Pub. Date: Mar. 30, 2017

(54) TEMPLATE-BASED REPORT GENERATION SYSTEM AND METHOD FOR INCORPORATING ACTIVE 3D ACTIVE OBJECTS

(71) Applicant: Siemens Aktiengesellschaft, München (DE)

(72) Inventors: Sridharan Palanivelu, Monmouth Jct., NJ (US); Amit Chakraborty, East Windsor, NJ (US)

(21) Appl. No.: 14/870,380

(22) Filed: Sep. 30, 2015

(51) Int. Cl. G06F 17/21; G06F 21/60; G06F 3/0484; G06T 19/00; G06F 17/22; G06F 17/24

(52) U.S. Cl. CPC G06F 17/211; G06F 17/2247; G06F 17/248; G06F 17/243; G06F 3/04842; G06T 19/00; G06F 21/602

(57) ABSTRACT

A method and system for generating a high-level language (i.e., PDF) report with embedded 3D objects. The report is prepared by using an XML template where selected 3D objects are imported into the template and enabled to be activated and manipulated by persons viewing the report, without the need to utilize vendor-specific 3D software. The XML template supports various types of 3D models from various data sources, such as engineering CAD models, medical volumetric data, etc. A specific XML fragment in the template is configured to allow for a 3D object (created using any type of software system) to be imported in “active” form to the document being created. Once the actual PDF report is generated, it may be distributed to various recipients who are then able to manipulate the 3D object(s).

### BACKGROUND

1. Technical Field

Aspects of the present invention relate to a template-based method for three-dimensional (3D) report generation and, more particularly, to the creation and use of an extensible mark-up language (XML) template for creating a report with one or more 3D objects that may be included into a higher-language document format (e.g., portable document format or PDF) and retain the active attributes of the 3D objects.

2. Description of Related Art

There are many industries and services that rely on the generation of three-dimensional (3D) images (objects) to transmit information. For example, many medical images are three-dimensional, and need to be transmitted from the person creating the image (e.g., radiologist) to a physician. Similarly, an engineer working on a failed component at a worksite location may need to transmit a three-dimensional image of the component to co-workers at another location.

Heretofore, the recipients of documents including three-dimensional images were required to have a specialty type of software to be able to fully view and manipulate the 3D object. Otherwise, the document recipient will only be able to view a two-dimensional (2D) representation of the object. Moreover, in cases where the image needs to be included in a larger report document (perhaps including multiple images), the same problems arise. Either the recipient of the report document had the specialty software required to manipulate the 3D images, or the report would be limited to 2D representations.

### SUMMARY

The needs in the prior art are addressed by aspects of the present invention, which relate to a template-based method that generates a 3D report and, more particularly, to the creation and use of an extensible mark-up language (XML) template that creates a report with one or more 3D objects that may be included into a higher-language document format (e.g., portable document format or PDF) and retain the 3D features.

In accordance with aspects of the present invention, a method and system is disclosed that generates a PDF report with embedded 3D objects, the 3D objects created using an XML template configured in accordance with aspects of the present invention. The XML template supports various types of 3D models from various data sources, such as engineering CAD models, medical volumetric data, etc.

In an embodiment of aspects of the present invention, an input template is created that includes a number of different XML <tags> for defining specific elements typically found in a PDF document (paragraphs, tables, images, etc.). Further, a specific XML template fragment is configured to allow for a 3D object (created using any type of software system) to be imported in “active” form to the document being created. Once the actual PDF report is generated, it may be distributed to various recipients who are then able to manipulate the 3D object(s).

A particular embodiment of aspects of the present invention takes the form of an apparatus that generates a high-level language report document including active 3D objects, the apparatus using an input template that defines a plurality of elements to be included in a generated report, at least one element defining a set of steps that import a selected 3D object into the generated report. Also utilized with the apparatus is a database of available 3D source documents. The report generation system includes an application processor that translates the input template into an XML format template, an edit engine in communication with the application processor (the edit engine utilized by an individual to activate the report generation system and supply input data to populate the XML template, including identifying at least one source file including a 3D object), and a report generator, responsive to the edited XML template created by the user, that identifies and imports the at least one source file including a 3D object and merging said at least one source file into the created XML template, generating as an output a high-level language report including active 3D objects.

Another embodiment of aspects of the present invention is defined as a method of generating a high-level language report including active 3D objections, comprising the steps of: (1) creating an input template defining a plurality of elements to be included in a generated report, at least one element defining a set of steps that import a selected 3D object into the generated report; (2) providing a database of available 3D source documents; (3) translating the input template into an XML format template; (4) populating the XML template with input data, including identifying at least one source file including a 3D object to be included as an active 3D object in the report; (5) formatting a high-level language report document, using as inputs the populated XML template and the database, identifying and importing the at least one source file including a 3D object and merging said at least one source file into the created XML template; and (6) generating as an output a high-level language report including active 3D objects.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary report generation system for creating PDF documents (or other higher-level language documents) including active 3D objections;

FIG. 2 illustrates an exemplary root node for use in creating a specific XML template for a document (“report”) being created that includes at least one active 3D object in the output PDF document;

FIG. 3 includes an XML template fragment defining the parameters of a page node used to define a particular “page” within a generated report (where each generated report may include one or more pages);

FIG. 4 is a listing of various child nodes that may be included within a page node;

FIG. 5 shows an XML template fragment defining the parameters of an “annotation3D” node used for importing a specified active 3D object into the generated report;

FIG. 6 shows an XML template fragment defining the parameters of a “chunk” of text that may be included as a child node on a particular page of a generated report;

FIG. 7 shows an XML template fragment defining the parameters of a “paragraph” that may be included as a child node on a particular page of a generated report;

FIG. 8 shows an XML template fragment defining the parameters of a “table” that may be included as a child node on a particular page, including a definition of table “rows” and “cells”;

FIG. 9 shows an XML template fragment defining the paragraphs of an “image” that may be included as a child node (within a paragraph node, table cell node, etc.);

FIG. 10 shows an XML template fragment defining the specific parameters used to create an active object in the form of a “button” that may be used to control the activation of the imported 3D object(s);

FIG. 11 is another embodiment of the XML template fragment of FIG. 10, in this case replacing a JavaScript® action with a “goto3D action” command; and

FIG. 12 shows an XML template fragment defining a specific set of attributes that may be used to encrypt the generated report prior to transmission.

### DETAILED DESCRIPTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a report generation system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) comprises one or more graphical display images enabling a user to interact with a processor or other device.

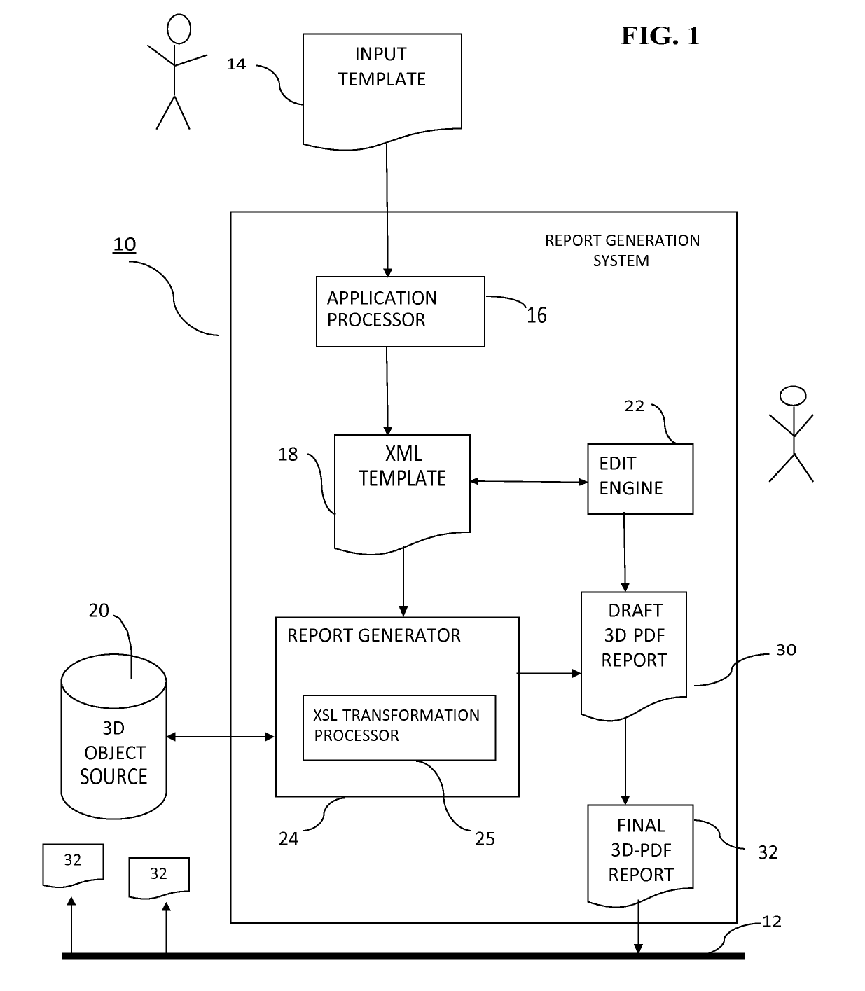

FIG. 1 illustrates an exemplary a report generation system 10 formed in accordance with aspects of the present invention to generate PDF reports that include “active” 3D objects. As will be described in detail below, report generation system 10 creates a “portable document format” (PDF) report (or a similar report base on any other suitable high-level language). For purposes of illustration, the following examples describe the generation of a PDF report. It is to be understood that the same principles apply to other types of reports that may be generated based on an extensible mark-up language (XML) template and the mention of “PDF” is only illustrative. In this regard, the disclosure of Extensible Markup Language (XML) 1.0 (5th Edition), W3C Recommendation, published by W3C on 26 Nov. 2008 and PDF Reference, Sixth Edition, version 1.23, published by Adobe Systems Incorporated, November 2006 are incorporated by reference herein in their entirety.

The created report may include one or more 3D objects, as well as various other types of active objects, including the 2D meta-data associated with these objects. Ultimately, as shown, a generated 3D-PDF report output (i.e., a PDF document including active 3D objects) is presented to a communication network 12, enabling transfer of the report to various destinations. The recipient(s) of this 3D-PDF report is (are) then able to manipulate the 3D objects using standard software (i.e., a freely-available reader) without requiring any type of vendor-specific 3D viewer.

Before the report can be generated, a person identified as the report template builder defines and constructs an input template 14. Input template 14 is created to include the definitions for the various elements that may be found in a typical PDF report, for example, tables, images, objects, text blocks, paragraphs and the like. Importantly, one of the elements included within input template 14 allows for 3D objects (configured via any program) to be imported into a report that is generated. The person building the report template may use either a graphical user interface (GUI) in defining the template, or create the template manually in those situations in which the template structure is relatively simple. Once input template 14 has been created, it is forwarded to an executable application 16 within report generating system 10, which transforms input template 14 into an XML template 18 ready to be populated by a user needing to generate a report.

As discussed above, 3D objects are created in a variety of circumstances. Medical personnel create 3D images during examinations and procedures; engineers create 3D images during the development of a new product (or performing analysis of existing products), architectures create 3D images of structures being built or renovated, etc. Indeed, there are many different professions which utilize 3D images, and need to transmit those images to other people and/or organizations that do not have the “specialized” vendor-specific software otherwise required for manipulating 3D objects created via a variety of different programs.

FIG. 1 illustrates a 3D object source 20 as a generalized definition for any of these various types of 3D objects. It is to be understood that when necessary, 2D meta-data may be associated with one or more 3D objects and similarly imported into a PDF report as it is being generated.

In accordance with aspects of the present invention, when report generation system 10 is invoked by a user, input template 14 supplies (via application 16) the various XML template elements to XML template 18, where the user is then able to construct the arrangement of a specific report (i.e., identifying the specific elements and other input data) via an edit engine 22. Once the template has been constructed to the satisfaction of the user, and the various required data elements have been provided by the user, XML template 18 is sent to a report generator 24 which builds the output 3D-PDF report. Report generator 24 interacts with 3D object source 20 to find the various source documents (i.e., 3D objects) requested by the user and defined within XML template 18. Report generator 24 then imports the specified 3D objects into XML template 18.

In one embodiment, report generator 24 may include an XSL transformation processor 25 that uses data from XML report template 18 and 3D objects from source 20 as inputs to generate a user-interactive collection of information in a generated 3D-PDF draft report 30 (other types of processors may be used in a similar manner). 3D-PDF draft report 30 may be edited by the user to create a final version of generated 3D-PDF document 32 provided as an output from report generations system 10.

A significant advantage of using XML in creating the report template in accordance with aspects of the present invention is that when using XML, there is a strict distinction between the content, representative and structure of the data used to generate the report. This is achieved since XML allows for the creation of tags in XML files, which tags can in turn include other tags. As a result, an XML file can set up a tree which leads to a structured distinction between different contents. Here, the “root” of the created tree is the desire to create a 3D-PDF report document, with a first level of child nodes beyond the root taking the form of “pages”, with each page then including one or more child nodes (i.e., paragraphs, 3D objects, graphs, tables, etc.) as explained in detail below.

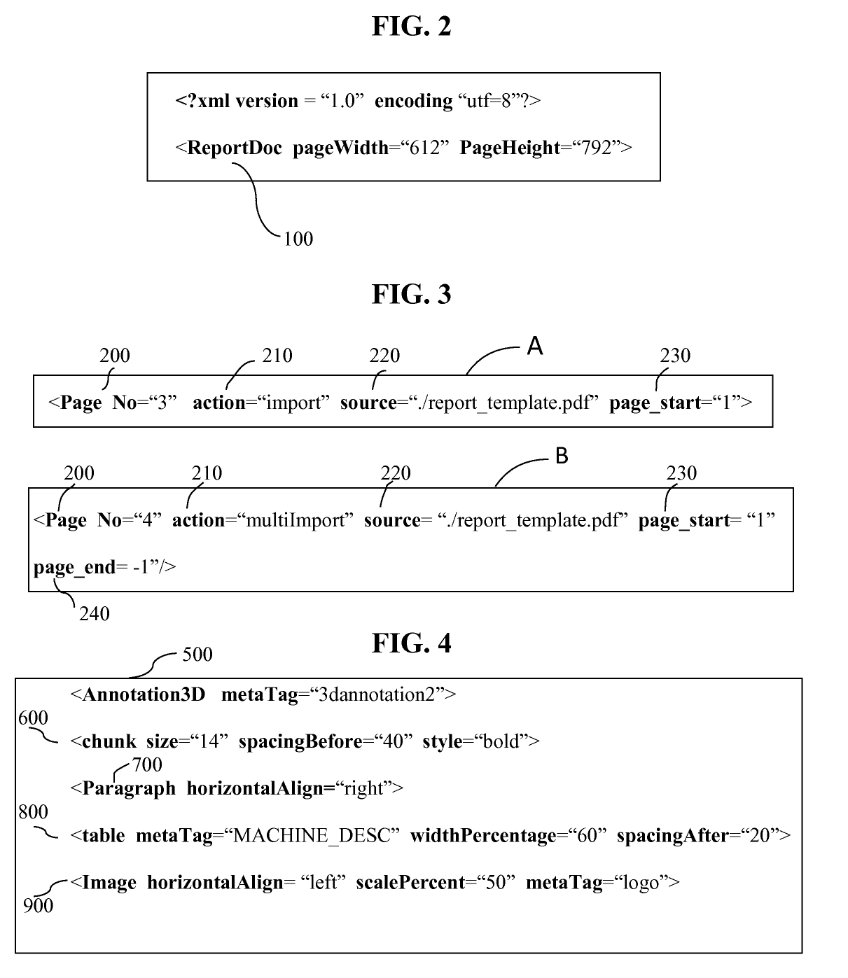

The root node of the XML-based template for creating 3D-PDF reports is shown in FIG. 2. Here, a <ReportDoc> tag 100 defines this particular template as associated with creating a PDF document within the XML parameters. Thus, when a user of the report generation system wants to create such a document, he will “call” for the ReportDoc process.

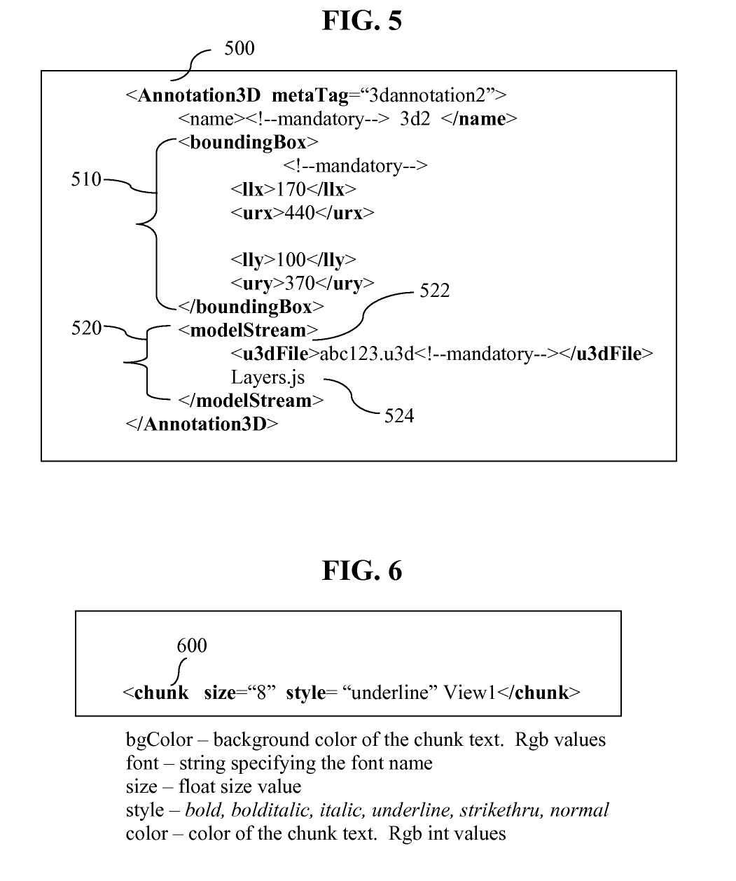

In accordance with the generation of a PDF document which obviously includes one or more individual pages, it is necessary define page parameters. All page definition nodes, as well as any children nodes within a page definition node, can have a metaTag attribute. For every page, the page size can be specified as “width, height”. If nothing is specified, a predetermined size can be presumed as default (i.e., letter size). FIG. 3 illustrates a specific XML template fragment associated with a <Page> tag 200 for importing a single page (shown as fragment A) or multiple pages (shown as fragment B). Referring to fragment A, the template parameters are shown as bolded text, with the data supplied by the user shown in conventional font (this same style is used in the description of the remaining template fragments as depicted in FIGS. 4-12).

<Page> tag 200 is shown as including a set of attributes, including “action” 210, “source” 220 and “page_start” 230. In this example, the data input by the user indicates that this is to be page “3”, with the “action” being to import information to this page. The “source” for this import is defined, in accordance with aspects of the present invention, as report_template.pdf. Any time that the action is to import, a source must also be defined, or an error will be generated. The attribute “page_start” 230 must be defined so that the document with the specified page number will be imported. In the “single page” import mode, discussed in detail in association with FIG. 4, this single page node may have one or more child nodes that are used to add further content particularly associated with the imported single page. In accordance with aspects of the present invention, one important child node includes the XML tag used to import 3D objects (discussed below in association with FIG. 5).

Referring to fragment B shown in FIG. 3, the same attributes 210, 220 and 230 are associated with <Page> tag 200. In this case, the “action” 210 attribute is defined by the user as being multilmport—defining that several pages from the source document are to be imported. Since this fragment is used to define a process for adding multiple pages, an attribute “page_end” 240 is also required. In the specific embodiment as shown in FIG. 3, attribute “page_end” 240 is shown to have a value of “−1”. This is a special value used to designate that the entire source document is to be imported. In this multi-page import mode, any child nodes of the page definition node may be ignored.

As mentioned above, in the creation of a 3D-PDF report using the XML template in accordance with aspects of the present invention, it is possible for each <Page> node to include one or more child nodes. FIG. 4 illustrates a set of four different types of child nodes that may be included in various page definitions. In accordance with aspects of the present invention, a first child node is defined with an <Annotation3D> tag 500, and is used to define the parameters associated with importing a 3D object (from source 20) into the template (and, ultimately, into the PDF report generated by the template). A second child node, in the form of a <chunk> tag 600 is used to define a specific block of text within the report. A <Paragraph> tag 700 defines a child node for specifying the particulars of a paragraph within the created 3D-PDF report, and a <table> tag 800, as defines a prescribed set of table parameters (rows and cells), in the manner discussed below. Also shown in FIG. 4 is an <image> tag 900, associated with defining a specific location on a page where an image (such as a jpeg file) is to be located. Each of these different types of child nodes is described in detail below.

FIG. 5 includes an XML template fragment illustrating the details of the 3D object importation function in accordance with aspects of the present invention. Thus, by including this XML template fragment in the report being generated, it is possible to import a U3D file into a PDF file in a way such that it may be displayed and viewed without needing any vendor-specific 3D viewer program. In addition to the elements that are mandatory for displaying the file itself, there are several optional child nodes that have also been specially developed to add specific behavior to the annotation. As discussed below, these child nodes include “buttons” and the like, that create a richer user interactivity via, for example, a JavaScript® (a registered trademark of ORACLE AMERICA, INC.) file that can be specified and executed when the annotation itself is activated.

With particular reference to the XML template fragment shown in FIG. 5, the methodology for importing a 3D object into a PDF report being created is defined by an one of the specific child nodes illustrated in FIG. 4, in this case defined as <Annotation3D> tag 500. This portion of the XML template requires that a bounding box be formed, within which the 3D object will be displayed. Here, a <boundingBox> tag 510 is used to define the specific attributes for creating a rectangle around the imported 3D object (shown as defining the corner locations llx, lly, urx, ury).

Also included within the Annotation3D node is a child node for controlling the merging of the actual 3D object file into the template being created. This is shown as a <modelStream> tag 520, and is used to invoke the transfer of a source file. into the template. Here, the source file is defined by a <u3dFile> tag 522, which identifies the source file as being a “3d” object (here a specific file abc123.u3d is identified). It is understood that the specific U3D file to be imported needs to be defined, and that requirement is shown as “mandatory” in FIG. 5. Also included as a child node within <modelStream> tag 520 is a JavaScript® command 524, in this case defined as “Layers”.

FIG. 6 includes an XML fragment defining the “chunk” child node, shown as <chunk> tag 600 in FIG. 4. As mentioned above, a chunk element may only include text. A set of attributes, also shown in FIG. 6, may be used to define the appearance of the text forming the “chunk”. Attributes include, but are not necessarily limited to, background color, font, size, style and color of the text.

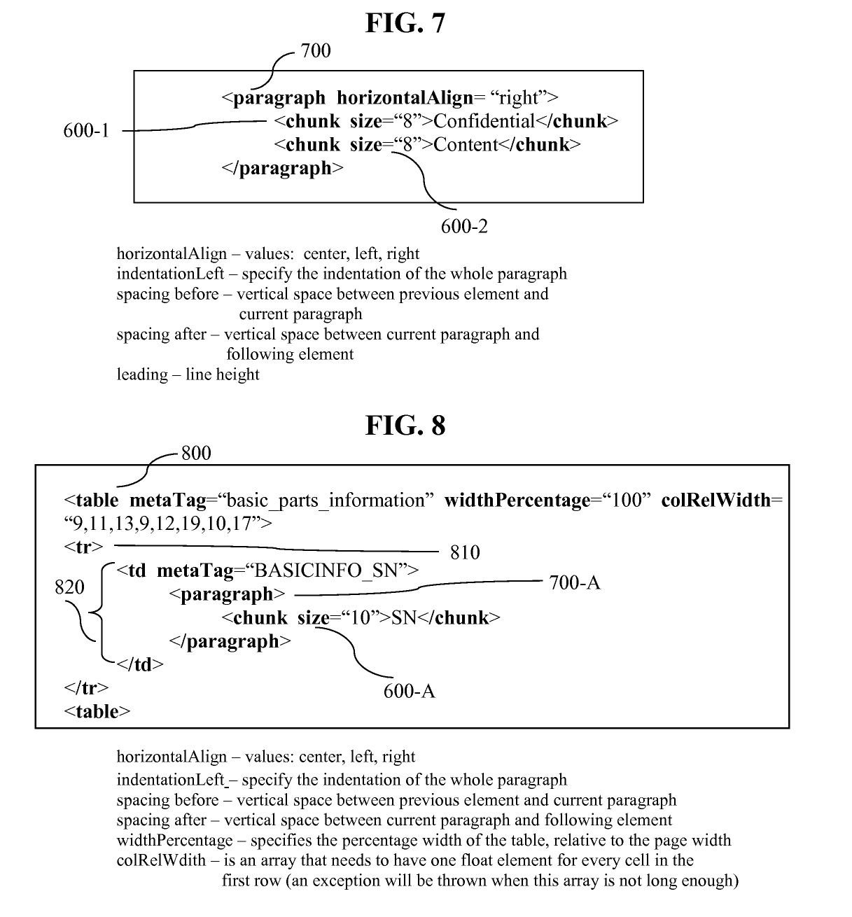

A paragraph element may include several chunks. FIG. 7 is an XML fragment associated with <Paragraph> tag 700 as shown in FIG. 4. In the particular configuration shown in FIG. 7, this paragraph node includes two separate chunk child nodes, represented by <chunk> tag 600-1 and <chunk> tag 600-2. In addition to including several independent chunks, a paragraph element may also include several attributes that are specified to set properties that modify all of the chunks included within the paragraph.

An exemplary set of possible paragraph attributes is also shown in FIG. 7, defining specific paragraph-related formatting definitions such as alignment of the paragraph with respect to the page, type of indentation, spacing between lines, spacing between paragraphs, etc. All of these attributes may be defined within <Paragraph> tag 700 by the user as the specific 3D-PDF report template is being created.

FIG. 8 depicts an XML template fragment used to define a table within the 3D-PDF report being generated (associated with <Table> tag 800 shown in FIG. 4). Table nodes are constructed in a manner similar to html tables, taking the form of “table rows”, using the tag <tr> 810, where each row includes a number of separate “table cells” (defined by <td> tag 820). Via the content XML file mechanism, single elements of the template can be deactivated. In the case of tables, that means that the number of columns in the table is chosen to be the number of activated cells in the first line of the table. Further, all cells of a given column are to be deactivated by the content XML file; otherwise, the cells will show up at different locations. The cell nodes themselves may include paragraph definitions or image definitions. In the particular configuration shown in FIG. 8, a single paragraph 700-A (including a single chunk 600-A) is included in each cell node.

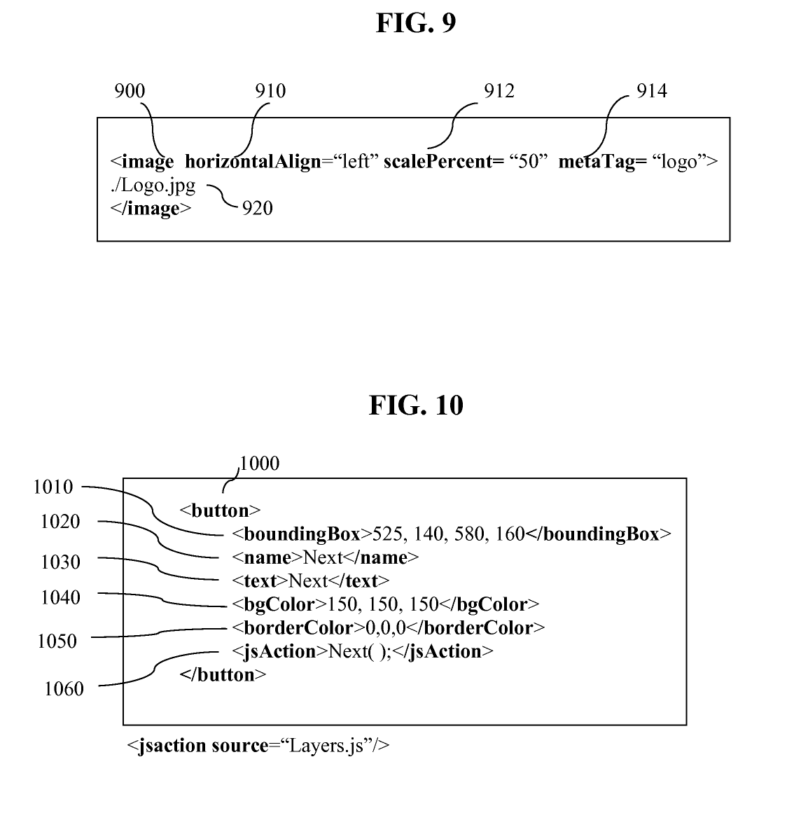

Images can be specified as either a child attribute of a page node, or as a child of a cell node within a table definition. FIG. 9 illustrates an exemplary XML fragment for defining an image, referred to as <image> tag 900 in FIG. 4. Referring to FIG. 9, <image> tag 900 is shown as including a set of attributes, in this case taking the form of “horizontalAlign” 910, “scale Percent” 912 and “metatag” 914. In this particular example, the user building the report has provided as data value of left for attribute 910, a 50% value for attribute 912, and calls for a logo as metatag 914. A file, for example a .jpg (Joint Photographic Experts Group) file, for the logo is shown as element 920 within <image> tag 900.

As mentioned above with the discussion of importing 3D object, the methodology in accordance with aspects of the present invention further provides the ability to create other active objects within the generated PDF report. For the purposes of successfully manipulating an imported 3D object, for example, it would be useful to have an active function in the form of a button that can be used to animate the object. As shown in FIG. 10, a <button> tag 1000 is used to designate one such type of active element. Here, <button> tag 1000 functions to place a form field below the 3D object, with the form field identified and configured to perform the animation.

Most of the child nodes included within <button> node 1000 of FIG. 10 are considered to be self-explanatory and are associated with the visual presence of the “button”. These include, as shown, a <bounding box> tag 1010, a <name> tag 1020, a <text> tag 1030 (in this case, indicating that the text Next is to be included within the bounding box), a <bgColor> tag 1040 (for defining the background color) and a <borderColor> tag 1050 (for defining the border color). The jsAction child node, defined as <jsAction> tag 1060, is different and uses a JavaScript® function that is executed when the button is clicked.

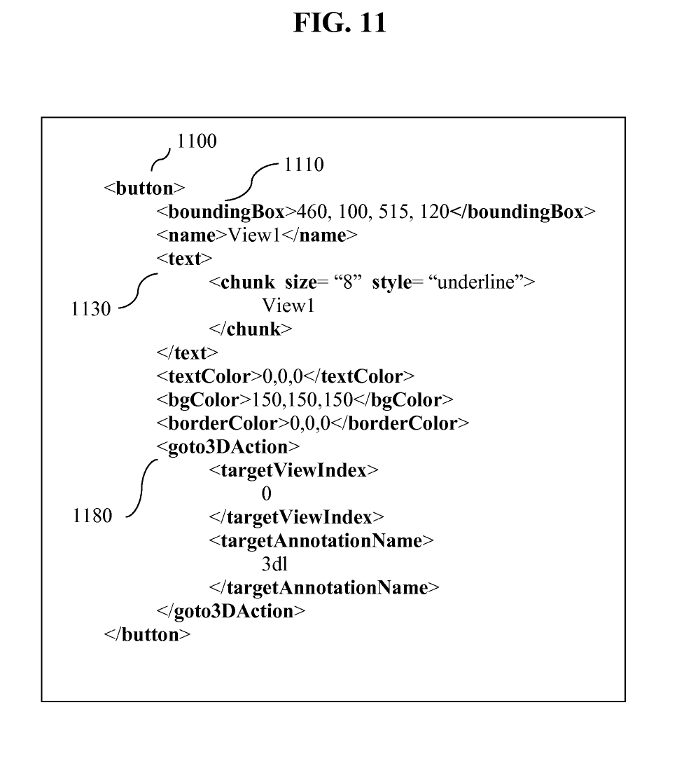

Instead of directly including the JavaScript® code in the jsAction node, an alternative configuration of a button node as shown in FIG. 11 includes a source path to a file including the JavaScript® code. As with the configuration shown in FIG. 10, <button> node 1100 utilizes the definition of a <boundingbox> 1110 and a <text> tag 1130. In this case, the JavaScript® code can be specified via the “source” attribute in the jsAction node. If a source attribute is indeed specified, the included text content of the jsAction node will be ignored. The jsAction can be replaced with a goto3DAction (tag 1180), which links a view that is activated when the button is clicked.

Again considering the button 1100, the <text>Next</text> node of the button 1100 can use a single chunk node instead of plain text, allowing for further layout specification of the button text.

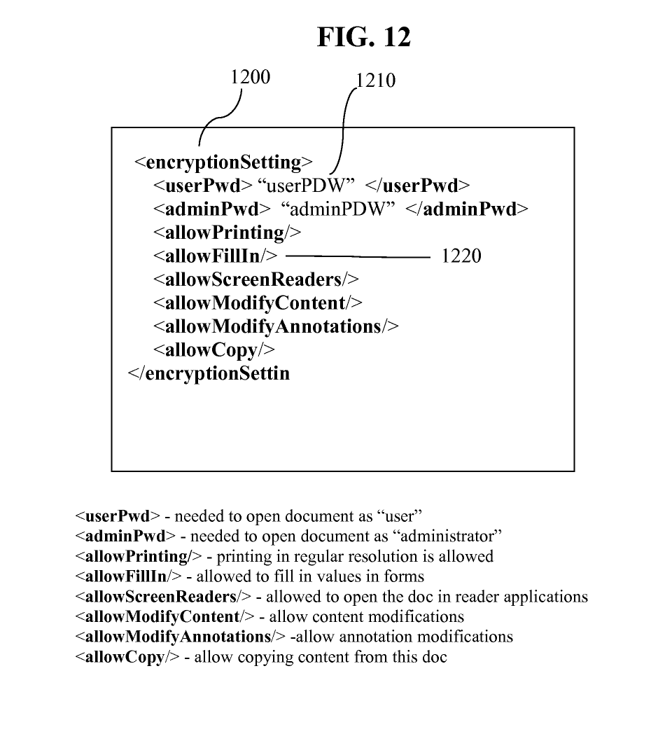

When necessary, the generated 3D-PDF report can include encryption features. FIG. 12 illustrates an XML template fragment for an <encryptionSetting> tag 1200 useful for this purpose. Some of the various permissions shown as encryption features include a <userPwd> tag 1210 (limiting access to the generated PDF report to those with an identified password), <allowFillIn> tag 1220 (limiting the reader's ability to edit the PDF report), etc. It should be understood that the detailed child nodes delineated within this encryption node are exemplary only, and various other types of permissions, passwords, etc., may be used to protect the 3D-PDF report being generated.

It is to be understood that the systems and methods described herein in accordance with aspects of the present invention may be implemented in various forms of hardware, software, firmware, special purpose processors, or a combination thereof. Aspects of the present invention are implemented in software as an application comprising program instructions that are tangibly embodied on one or more program storage devices (e.g., hard disk, magnetic floppy disk, RAM, CD Rom, DVD, ROM, etc.), and executable by any device or machine comprising suitable architecture.

It is to be further understood that because the constituent system modules and method steps depicted in the accompanying drawing figures are implemented in software, for example, the actual connections between the system components (or the flow of the process steps) may differ depending upon the manner in which the application is programmed. Given the teachings herein, one of ordinary skill in the related art will be able to contemplate these and similar implementations or configurations in accordance with aspects of the present invention.

What is claimed is:

1. A report generation system that generates a high-level language report document including active three-dimensional (3D) objects, the report generation system responsive to an input template defining a plurality of elements to be included in a generated report, at least one element defining a set of steps that import a selected 3D object into the generated report, and a database of available 3D source documents, the report generation comprising:
an application processor that translates the input template into an extensible mark-up language (XML) format template;
an edit engine in communication with the application processor, the edit engine utilized by an individual to activate the report generation system and supply input data to populate the XML template, including identifying at least one source file including a 3D object; and
a report generator, responsive to the edited XML template created by the user, that identifies and imports the at least one source file including a 3D object and merging said at least one source file into the created XML template, generating as an output a high-level language report including active 3D objects.

2. The apparatus according to claim 1 wherein the high-level language of the generated report is a portable document format (PDF).

3. The apparatus according to claim 1 wherein the input template includes definitions for report elements including at least one of: page, paragraph, table, 3D object, image.

4. The apparatus according to claim 1 wherein the input template includes active elements, utilized to control activation of the at least one 3D object included in the generated report.

5. The apparatus according to claim 1 wherein the apparatus further comprises an edit interface communicating with the output of the report generator, allowing the user to perform edit functions on the generated report prior to transmitting the report as an output of the apparatus.

6. The apparatus according to claim 1 wherein the apparatus is coupled to a communication network, wherein the generated report document is available to be sent to identified individuals via the communication network.

7. The apparatus according to claim 1 wherein the input template includes an encryption element available to be included in a created XML template.

8. The apparatus according to claim 7 wherein the encryption element is used to control at least one of the following features: ability to open the generated report, ability to edit the generated report; ability to print the generated report; and ability to copy the generated report.

9. A method of generating a high-level language report including active three-dimensional (3D) objections, comprising:
creating an input template defining a plurality of elements to be included in a generated report, at least one element defining a set of steps that import a selected 3D object into the generated report;
providing a database of available 3D source documents; and
translating the input template into an extensible mark-up language (XML) format template;
populating the XML template with input data, including identifying at least one source file including a 3D object to be included as an active 3D object in the report; and
formatting a high-level language report document, using as inputs the populated XML template and the database, identifying and importing the at least one source file including a 3D object and merging said at least one source file into the created XML template; and
generating as an output a high-level language report including active 3D objects.

10. The method according to claim 9 wherein the high-level language of the generated report is a portable document format (PDF).

11. The method according to claim 9 wherein the input template includes definitions for report elements including at least one of: page, paragraph, table, 3D object, image.

12. The method according to claim 9 wherein the input template includes active elements, utilized to control activation of the at least one 3D object included in the generated report.

13. The method according to claim 9 wherein the method further includes editing a formatted document to include any desired changes prior to generating the final report.

14. The method according to claim 9 wherein the method further includes transmitting the generated report over a communication network to at least one identified receiver.

15. The method according to claim 9 wherein the method further includes encrypting the generated report prior to transmission.

16. A program storage device readable by machine, tangibly embodying a program of instructions executable by the machine to perform a method that generates documents, the method comprising:
executing an input template defining a plurality of elements to be included in a generated report, at least one element defining a set of steps that import a selected three-dimensional (3D) object into the generated report;
translating the input template into an extensible mark-up language (XML) format template;
populating the XML template with input data, including importing at least one source file including a 3D object to be included as an active 3D object in the report; and
formatting a high-level language report document, using as inputs the populated XML template and the database, identifying and importing the at least one source file including a 3D object and merging said at least one source file into the created XML template; and
generating as an output a high-level language report including active 3D objects.

17. The program storage device of claim 16, wherein the high-level language of the generated report is a portable document format (PDF).

18. The program storage device of claim 16 wherein the device further comprises a XSL transformation processor that merges the at least one active 3D object with the XML template.

19. The program storage device of claim 16 wherein the device further comprises an encryption element that protects the content of the generated report prior to transmission.

20. The program storage device of claim 16 wherein the input template includes definitions for report elements including at least one of: page, paragraph, table, 3D object, image.
